(19) United States
(12) Patent Application Publication
(10) Pub. No.: US 2009/0162124 A1
(43) Pub. Date: Jun. 25, 2009

(54) KEYBOARD

(75) Inventors: CHU-BIAO LIAO, Shenzhen City (CN); GEN-HUA LIU, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/239,829

(22) Filed: Sep. 29, 2008

(30) Foreign Application Priority Data
Dec. 19, 2007 (CN) 200710203244.X

(51) Int. Cl. B41J 5/00

(52) U.S. Cl. 400/491.1

(57) ABSTRACT

A keyboard is used to provide comfort to users' wrists. The keyboard includes a main body, a cable, and an air cushion. The cable is connected to the main body. The air cushion is connected to the cable.

### BACKGROUND

1. Field of the Invention

The present invention generally relates to a keyboard having wrist cushions.

2. Description of Related Art

Computers are widely used in our works. Some users always spend a long time, e.g., 8 hours a day in working with a computer, which causes tiredness and discomfort to them both physically and emotionally. For example, when a user inputs information into a computer by a keyboard, he has his forearms placed on a desk supporting the keyboard, wrists crooked, palms raised, and keeps fingers pressing keypads of the keyboard. If the user keeps working for a long time, the wrists may be hurt.

Therefore, an improved keyboard is needed in the industry to address the aforementioned deficiency.

### SUMMARY

A keyboard is used to provide comfort to users' wrists. The keyboard includes a main body, a cable, and an air cushion. The cable is connected to the main body. The air cushion is connected to the cable.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a schematic diagram showing a keyboard in accordance with an exemplary embodiment.

FIG. 2 is a schematic diagram showing the keyboard viewed from another aspect.

### DETAILED DESCRIPTION

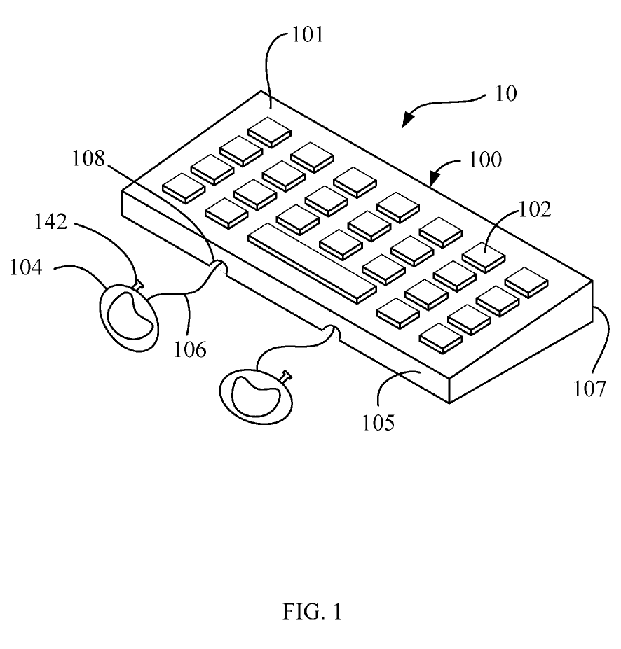

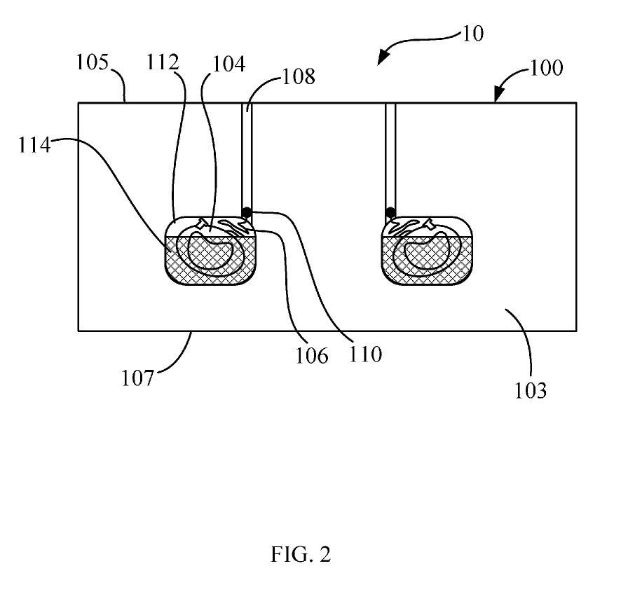

Referring to FIGS. 1 and 2, a keyboard 10 in accordance with an exemplary embodiment includes a main body 100, a plurality of input keys 102, two air cushions 104, two cables 106, two stators 110, and two block portions 114.

The keypads 102 are disposed on an upper side 101 of the main body 100. Two parallel grooves 108 and two housings 112 are defined in a lower side 103 of the main body 100. Each groove 108 partially extends from a front side 105 of the main body 100 towards a back side 107 of the main body 100. Each groove 108 communicates with a corresponding housing 112. Each block portion 114 partially covers a corresponding housing 112 correspondingly. In the embodiment, the block portions 114 are nets. In other embodiments, the block portions 114 may be sheets, strips, etc. The stators 110 are respectively fixed in the two grooves 108. Each stator 110 is near a corresponding housing 112. The cables 106 are respectively connected to the stators 110. The air cushions 104 are respectively connected to the cables 106. Each air cushion 104 has an ellipsoidal shape and defines a cavum inside, and also includes an air faucet 142. The air cushions 104 are made of elastic materials, such as silicon rubber.

When the keyboard 10 is not used, the air cushions 104 and the cables 106 are respectively received in the housings 112. The block portions 114 prevent the air cushions 104 and the cables 106 from falling out of the housings 112. When the keyboard 10 is used, the air cushions 104 can be taken out from the housings 112 and placed in front of the keyboard 10. Each cable 106 is pulled out from a corresponding housing 112 via a corresponding groove 108. The air cushions 104 are further inflated with air through the air faucets 142. Subsequently, a person using the keyboard 10 can rest his wrists on the air cushion 104. The air cushions 104 will provide comfort to his wrists.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A keyboard comprising:
a main body;
a cable connected to the main body; and
an air cushion connected to the cable.

2. The keyboard according to claim 1, further comprising a plurality of keypads disposed on an upper side of the main body.

3. The keyboard according to claim 1, wherein a back side of the main body defines a housing receiving the air cushion.

4. The keyboard according to claim 3, wherein the back side of the main body further defines a groove communicating with the housing.

5. The keyboard according to claim 4, wherein the groove extends from a front side of the main body towards a back side of the main body.

6. The keyboard according to claim 5, further comprising a stator fixed in the groove and near the housing.

7. The keyboard according to claim 6, wherein the cable is connected to the stator.

8. The keyboard according to claim 6, further comprising a block portion partially covering the housing.

9. The keyboard according to claim 8, wherein the block portion is a net.

10. The keyboard according to claim 1, wherein the air cushion comprises an air faucet used for inflating the air cushion.

11. The keyboard according to claim 1, wherein the air cushion has an ellipsoidal shape.

12. The keyboard according to claim 1, further comprising another cable connected to the main body, and another cushion connected to the another cable.

13. The keyboard according to claim 1, wherein the air cushion is made of an elastic material.

14. The keyboard according to claim 1, wherein the air cushion is made of silicon rubber.
